(19) United States
(12) Patent Application Publication
(10) Pub. No.: US 2017/0200085 A1
(43) Pub. Date: Jul. 13, 2017

(54) Creation of Abiotic-Biotic Civilization

(71) Applicant: Anuthep Benja-Athon, New York, NY (US)

(72) Inventor: Anuthep Benja-Athon, New York, NY (US)

(73) Assignee: Anuthep Benja-Athon, New York, NY (US)

(21) Appl. No.: 14/992,773

(22) Filed: Jan. 11, 2016

(51) Int. Cl. G06N 5/04; H04L 29/08

(52) U.S. Cl. CPC G06N 5/04; H04L 67/10

(57) ABSTRACT

The networked computers for inferring and foretelling needs, necessities and utilizations of tangible and intangible resources and assets having the innovative computer programs for instructing and specifying networked repositories what to and how to structure, express and manifest individual repositories-specific data in and among networked repositories wherein an innovative system of analogies effect networked repositories to synchronously and spontaneously get, push and render, receive and reverse compose same, equivalent and similar meaningful and comprehensible associations of data, expressions and manifestations.

### FIELD OF INVENTION

### Background of the Invention

The global accesses to goods and services at best are rudimentary, hugely fragmented and little hits and mostly misses despite the Internet and relatively efficient networks of cloud servers, computers and mobile communications devices blanketing earth with relatively little benefits for people and nations the past decades and future of the networked people. Among 7 billion people, companies and corporations, billions must ponder the Internet impotence being caused by people. The adverse and tragic consequences and implications are immense for people and nations. The present invention provides the technology for going above and beyond said technology ceiling for said people and nations.

### SUMMARY OF THE INVENTION

The networked computers for inferring and foretelling needs, necessities and utilizations of tangible and intangible resources and assets having the innovative computer programs for instructing and specifying networked repositories what to and how to structure, express and manifest individual repositories-specific data in and among networked repositories wherein an innovative system of analogies of languages, images and videos effect networked repositories to synchronously and spontaneously get, push and render, receive and reverse compose same, equivalent and similar meaningful and comprehensible associations of data, expressions and manifestations. Consequently, said networked repositories amass and bundle individual associations of data, expressions and manifestations to infer, extrapolate and foretell said needs, necessities and utilizations in and among said networked repositories.

### DESCRIPTION OF THE PREFERRED EMBODIMENTS

The present invention provides a system for inferring, extrapolating and foretelling needs, necessities and utilizations of tangible and intangible resources and assets for people and groups of people by networks of cloud servers, computers and mobile communication devices such as, but not limited to, billions of smartphones comprising networked repositories attaching an innovative operating system, said networked repositories having processing means, storage means aka memories for storing means and data and associations described herein, devices identities and display screens including touch-sensitive screens collectively henceforth known as devices possessed and/or used by at least 5 billion people having diverse genetics, phenotypes including health and well being, occupations, interests, avocations and standards of living collectively henceforth known as individuals and groups of people having phenotypes data.

The present invention created said innovative operating system for rendering a plurality of software, instructions and specifications for instructing and specifying said networked repositories what to and how to constitute and render plurality of interactive adaptable and editable platforms endowed with means, said data, associations, products and outcomes in and among said networked repositories described and implied herein. Said networked repositories are ad libitum, initiating, ad libitum receiving and/or ad libitum requesting networked repositories. In other words, using commercial networking means, the present invention enables said networked repositories to initiate. request, receive and/or share any and all infra. Said initiating, requesting and receiving networked repositories having accredited and recognized network connectivities to synchronously and spontaneously get, push, receive and render same, equivalent and similar copies of real-time data and associations infra.

The present invention provides said system with said innovative operating system comprising unique computer programs for instructing and specifying networked repositories in said networks what to and how to create, grow, compile and use adaptable and expanding relational data in and among said networked repositories. Said adaptable and expanding relational data rendered and shared by and among said networked repositories in billions of said cloud servers, computers and mobile communication devices especially billions of said smartphones effecting said system for rendering and managing said resources and assets such as, but not limited to human, healthcare, health, medicine and surgery, behaviors, perceptions, oral and parental consumptions of calories, fluids and pharmaceuticals, chronic cares, longevity resources and assets, capitals and wealth, finance, productivities, equities, insurance, investments, retirements, pensions and decision makings collectively henceforth known as professional, technical and lay subjects, matters and fields*, where * connotes any relational subjects, matters and fields associating with said needs, necessities and utilizations of tangible and intangible resources and assets applicable to said individuals and groups of people associating with said networked repositories as represented herein.

Said professional, technical and lay subjects, matters and fields* are associated with said networked repositories associating with individuals and groups of people having knowledges, skills and/or expertises in said professional, technical and lay subjects, matters and fields* being represented by the diverse professional, technical and lay subjects, matters and fields herein of this one patent applicant having and networking said networked repositories to create and compile supra to participate in the achievement of the objectives and goals of the present invention.

Said innovative operating system—enabled by the Internet, commercial networking means, firewalls and a plurality of cloud software and web browsers,—is available to and operating in and among said networked repositories to render and compile unstructured and structured information and data in nature, billions of people, animals and other living things including small animated particles such as, but not limited to, viruses and the likes and machines in and among said networked repositories wherein said innovative operating system engineer said information and data into adaptable and editable engineered information and data.

First example, said innovative operating system instructing and specifying said networked repositories what to and how to create and compile engineered phenotypes data of people and animals and to express and manifest innate implicit and explicit data embodied in said engineered data from unstructured and structured information and data input in and sharing by and among said networked repositories. Said unstructured and structured information and data and associating engineered data embodied with innate implicit and explicit data intrinsic in said engineered data are organized, stored and compiled in said storage means in and among said networked repositories.

To create and compile, express, manifest and share individual engineered phenotypes data and relational innate implicit and explicit data intrinsic in individual engineered data in and among said networked repositories, said innovative operating system instructing and specifying said networked repositories how to and what to render a plurality of individual first interactive electronic platforms for constituting and engineering said first unstructured and structured information and data, such as, but not limited to, said phenotypes data into first engineered relational phenotypes data endowed with innate data having specific idiosyncratic trends and patterns whenever said networked repositories associating elements of unstructured and structured phenotypes data with said a plurality of individual first interactive electronic platforms in and among said networked repositories. Said first engineered phenotypes data endowed with innate data are stored and compiled in said storage means by and among said networked repositories.

The system according to claim 1 where said means for engineering said phenotypes data and pressing and manifesting said innate data endowed in said engineered phenotypes data and related expressions and manifestations and related comprise said relational goods-services category-subcategory-abiotics biotics specificities data are said means for said networked repositories to engineer said innate data endowed in said engineer phenotypes data;

said relational goods-services category subcategory-abiotics biotics specificities data are said means for said networked repositories to engineer said innate data endowed in said engineer phenotypes data; said categories of diagnostics data are means for said networked repositories to pattern, trend and align said innate data with patterns, trends and alignments of said expressions and manifestations stored in said storage means; said networked repositories-rendered plurality of first interactive electronic platforms for constituting and engineering said innate data intrinsic in engineered phenotypes data, said first interactive electronic platforms having adaptable and editable hierarchy data embodied with said means; said networked repositories for expressing and manifesting said innate data in said engineered sequences of elements of phenotypes data in associations with said networked repositories-rendered adaptable and editable hierarchy data and expressing and manifesting said innate data endowed in said engineered phenotypes data; said relational abiotics biotics data-abiotics bioties specificities data for specifying said networked repositories how to engineer sequences of elements in said phenotypes data so that said engineered phenotypes data are endowed with correct and accurate data patterns and trends which are same as, equivalent and similar to or align with data patterns and trends of said expressions and manifestations associating with said related stored in said storage means;

said relational goods-services category-subcategory-abiotics biotics specificities data for specifying said networked repositories how to engineer sequences of elements in said phenotypes data so that said engineered phenotypes data are endowed with correct and accurate data patterns and trends which are same as, equivalent and similar to or align with data patterns and trends of said expressions and manifestations associating with said related stored in said storage means; and

Said operating system instructing said networked repositories how to create the goods-services category-subcategory-biotics biotics specificities software, said software constituting and rendering relational goods-services category-subcategory-abiotics biotics specificities data, said data expressing and manifesting said implicit and explicit data embodied in said phenotypes data associating with said adaptable and editable hierarchy data, said means having said relational professional and technical terminologies and lay terminologies analogies.

Said operating system instructing said networked repositories how to create the abiotics biotics data-abiotics biotics specificities software, said software constituting and rendering relational abiotics biotics data-abiotics biotics specificities data which are a means engineering and manifesting said implicit and explicit data embodied in said phenotypes data, said means having said relational professional and technical terminologies and lay terminologies analogies.

A case in point, representing said professional, technical and lay subjects, matters and fields is one of the preferred embodiments of the present invention is the medical subjects, matters and fields—wherein this patent applicant and physician is the expert—affecting individuals and groups of people and more using said networked computers and mobile communication devices having said networked repositories for rendering said first example. There are immense data and vast permutations of structured and unstructured data in said professional, technical and lay subjects, matters and fields. One, few or more elements of unstructured or random phenotypes data is/are associated with said individual first interactive electronic platforms by and among said networked repositories such as, but not limited to, skin mucous membranes hyperpigmentation or more than one elements such as, but not limited to, Waterhouse-Friderichsen syndrome, asthenia in said plurality of individual first interactive electronic platforms rendered in and said networked repositories. Said innovative operating system instructing and specifying said networked repositories what to and how to apply said one, few or several elements to scan database in said storage means and retrieve relational data stored and compiled in and among said networked repositories and, consequently, to render, express and manifest said retrievals as engineered phenotypes data endowed with innate data based on said relational goods-services category-subcategory-abiotics biotics specificities data and relational abiotics biotics data-abiotics in said storage means to compile, express and manifest, for example, individual groups of relational elements such as, but not limited to, two representative engineered phenotypes data—see infra—of many or numerous engineered phenotypes data comprising structured relational elements expressing and manifesting said associations as in said representative medical subjects, matters and fields as follows:

Group #1: asthenia, weakness, fatigue; apathy; nausea; vomiting; anorexia; weight loss; skin mucous membranes hyperpigmentation; vitiligo; decreased pubic axillary hair; insidious sudden sharp pain abdomen; vague abdominal pain; hyponatremia; salt craving; diarrhea; constipation; hypoglycemia; arterial hypotension; postural hypotension; syncope; vertigo; personality changes; irritability: restlessness; bilateral adrenal cortex destruction; postpartum bilateral adrenal hemorrhage; idiopathic adrenal cortical atrophy; nonspecific adrenal cortical atrophy; autoimmune adrenal cortical atrophy; adrenalitis; hypocortisolism; chronic granulomatous disease; tuberculosis; mycobacterium avium-intracellulare; sarcoidosis; amyloidosis; fungal infections; coccidioidomycosis; cryptococcosis; histoplasmosis; AIDS; HIV; Kaposi's sarcoma; cytomegalovirus; CMV necrotizing adrenalitis; sarcoidosis; amyloidosis; postoperative complications; adrenoleukodystrophy; adrenomyeloneuropathy; bilateral adrenal cortical hemorrhage; adrenal infarction; familial adrenal insufficiency; cancerous destruction adrenal glands; Waterhouse-Friderichsen syndrome; tumor metastatses; subnormal ACTH stimulation response;

Group #N: asthenia, sore throat; fever; weakness; toxic appearance; listlessness; pallor; voice changes; foul breath; headache; neck edema; edematous submandibular anterior neck; cervical lymphadenopathy; bull-neck diphtheria; swollen tonsils uvula; thick speech; pseudomembrane formation; tachycardia; vascular collapse; dysrhythmias; conduction disturbances; complete conduction heart blocks; dilated cardiomyopathy; facial numbness; gingivial numbness; lingual numbness; numbness; dysphonia; dysphagia; limb paresthesia; cranial motor nerve pareses; respiratory abdominal trunk muscle weakness; paresis; paralysis; quadriparesis; quadriplegia; peripheral sensory deficits; sensory ataxia; limb pain; autonomic disturbances; severe arterial hypotension; where #N=#2 or >#2. Said first engineered phenotypes data—represented by supra—endowed with innate data are stored and compiled in said storage means by and among said networked repositories,

Said associations in said storage means having hierarchy data possessing subjects-, categories- and subcategories-specific relational professional and technical, technical terminologies and lay terminologies and analogues professional and technical, technical and lay words, terms, phrases, sentences, images, video associating with time temporal, characters, features demographics 2-D and 3-D features and specificities, locations, places and events and any combination thereof having specific idiosyncratic trends and patterns

Not to be expressed and manifested herein but in and among said networked repositories, said a (infinitely) small example of engineered phenotypes data are endowed with innate data such as limited to, phenotypic and genotypic constitutions of associating individuals and groups of people based on stored and compilations of amassed and bundled relational data on categories of demographics, genetics and phenotypes, chief complaints, injuries, symptoms, signs, review of systems, physical examinations and findings, differential diagnoses, laboratory, test, pathology, diagnostics, measurements and pharmaceuticals data, etc. Said operating system instructing and specifying said networked repositories what to and how to repeatedly express, manifest and manage, edit and expand said complex adaptable and editable associations and their derivatives—described infra—in said plurality of individual first interactive adaptable and editable electronic platforms rendered in and among initiating, receiving and requesting networked repositories—see infra.

Said data and associations can be managed including, but not limited to, corrections, editions, additions and deletions of said data and associations in said templates and in said storage means by and among said networked repositories. Said brief description of one of the preferred embodiments of the present invention is a representation of said professional, technical and lay subjects, matters and fields* in and among said networked repositories. Corollary, said description is applicable to said professional, technical and lay subjects, matters and fields* in and among said networked repositories.

Further to supra, said operating system creating the differential diagnostics software for creating differential diagnostics data enabling said networked repositories to define and identify individual associations among huge associations in and among said networked repositories which consequently enable the associations infra. Said differential diagnostics data according to said professional, technical and lay subjects, matters and fields*—in terabytes being generated, stored and managed by and among said networked repositories—are vast and beyond the scope of this application. However, said representative medical subjects, matters and fields comprise, but not limited to, immense associations of relational medical words, terms, phrases and sentences, English and non-English lay words, terms, phrases and sentences, images and videos in immense engineered data and innate data, patterns and trends in the medical categories of demographics, chief complaints, injuries, symptoms, signs, review of systems, physical examinations and findings, differential diagnoses, laboratory, test, pathology, diagnostics, measurements and pharmaceuticals data, etc. being vastly generated, stored, expanded and managed in and among said networked repositories.

Said operating system instructing and specifying said networked repositories how to use said differential diagnostics data to define and identify individual associations among huge associations in and among said networked repositories and to instruct and specify said networked repositories what to and how to render associations of relational subjects, matters and fields associating with said needs, necessities and utilizations of tangible and intangible resources and assets applicable to said individuals and groups of people associating with said networked repositories. A case in point, further to the above example Group #1-Group #N, said operating system instructing and specifying said networked repositories how to use said differential diagnostics data to define and identify said Group #1-Group #N in and among said networked repositories. Said operating system to create and compile, express, manifest and share individual second engineered phenotypes data and relational innate implicit and explicit data intrinsic in individual engineered data on specific medical subjects, matters and fields in and among said networked repositories, said innovative operating system instructing and specifying said networked repositories how to and what to render a plurality of individual interactive first adaptable and editable electronic platforms for expressing and manifesting said first engineered phenotypes data endowed with said innate data having said hierarchy data having specific idiosyncratic trends and patterns as adaptable and editable real-time expressions and manifestations in a plurality of interactive adaptable and editable scrollable, pop-ups and drop-downs of real-time data in said interactive first adaptable and editable electronic platforms whenever said networked repositories associating elements of unstructured and structured phenotypes data with real-time data whereby said operating system instructing and specifying said networked repositories how to apply said differential diagnostics data to define and identify said individual associations among huge associations in and among said networked repositories, to express paid manifest said individual associations viewable, useable, manageable, editable and expandable in said interactive first adaptable and editable electronic platforms. Said operating system further instructing and specifying said networked repositories what to and how to render said associations of relational subjects, matters and fields* associating with said needs, necessities and utilizations of tangible and intangible resources and assets applicable to said individuals and groups of people based on said patterns and trends in said associations in and among said networked repositories.

Said operating system further instructing and specifying said networked repositories what to and how to render said associations of relational subjects, matters and fields associating with said needs, necessities and utilizations of tangible and intangible resources and assets applicable to said individuals and groups of people based on said patterns and trends in said associations in and among said networked repositories. Further to supra, said operating system creating the professional and technical Terminologies-Lay Terminologies Thesaurus software for instructing said networked repositories that to and how to constitute and render relational professional and technical terminologies-lay terminologies analogies aka characters such as, but not limited to, English and non-English. Referencing to said representative medical subjects, matters and fields, a tiny representation of a vast relational professional and technical terminologies-lay terminologies analogies in said professional, technical and lay subjects, matters and fields* aka types of analogies or characters—in terabytes generated, stored, expanded and managed in and among said networked repositories—are beyond the scope of this application is as follows:
septicemia; infected blood;
asthenia; abnormal physical weakness;
asthenia; lack of energy;
facial rounding; moon face;
anorexia; lack of appetite and inability to eat;
hypertension; high blood pressure;
hyperglycemia; high blood sugar;
ankle edema; swollen ankle;
intractable abdominal pain; intractable abdominal pain;
hyponatremia; low blood sodium;
hyperpigmentation; increased skin pigment;
diarrhea; abnormally frequent large volume of watery stool;
limb paresthesias; abnormal limb sensations;
tachycardia; rapid heart beats;
neck edema; swollen neck;
edematous submandibular anterior neck; swollen jaw neck;
N; n;
image_N; image_n;
video_N; video_n:
where N; n represents very large quantity of relational professional and technical terminologies-lay terminologies analogies in relational professional, technical and lay subjects, matters and fields* and said representative structure is one of many preferred embodiments of the present invention. Said professional and technical terminologies-lay terminologies thesaurus software provides a plurality of interactive adaptable and editable platforms having scrollable, pop-ups and drop-downs for creating, uploading into said storage means and editing said analogies in and among said networked repositories whereby said platforms also enable the repeated viewings, uses, managements, editions and expansions of said analogies in and among said networked repositories.

Said operating system further instructing and specifying said networked repositories how to amass and bundle said individual associations based on relations of engineered sequences of elements of phenotypes data, sequences of elements of said means for said networked repositories to engineer said innate data endowed in said engineer phenotypes data and sequences of elements of said means for said networked repositories to pattern trend and align said innate data in said storage means.

Based on said networks, said relational professional and technical terminologies-lay terminologies analogies specifying said initiating, receiving and requesting networked repositories what to and how to synchronously and spontaneously constituting and getting same, equivalent and similar real-time useful, meaningful and comprehensible copies of said innate data, expressions and manifestations and related associating with individuals and groups of individuals based on amassed and bundled relational professional and technical terminologies and lay terminologies in said engineered phenotypes data, innate data, expressions and manifestations in said storage means. In other words, said ad libitum initiating, ad libitum receiving and/or ad libitum requesting networked repositories are associated with individuals and groups of people—having knowledges, skills and/or expertises in said professional, technical and lay subjects, matters and fields*—using said devices. Said operating system further instructing and specifying said networked repositories said relational professional and technical terminologies-lay terminologies analogies to synchronously and spontaneously constituting getting same, equivalent and similar real-time useful, meaningful and comprehensible copies of said associations which can be read and heard via means such as, but not limited to, languages, images and/or videos which a useful, meaningful and comprehensible by said individuals and groups of people.

The present invention provides a system for inferring, extrapolating and foretelling needs, necessities and utilizations of tangible and intangible resources and assets for people and groups of people by networks of cloud servers, computers and mobile communication devices such as, but not limited to, billions of smartphones comprising networked repositories attaching an innovative operating system. In other words, the present invention is creating the abiotic-biotic Civilization wherein said networks and networked repositories create and manage global civilization, behaviors, thoughts, consumptions of health care, assets and materials, commerce and businesses, health, activities of daily living, functions and future of people. The present invention provides said operating system to provide said relational professional and technical terminologies-lay terminologies analogies to attach to and among said networked repositories whereby said analogies are synchronously, spontaneously and constantly used, managed, edited and expanded in real-time by and among said networked repositories. In other words, by said operating system instructing said networked repositories to apply said associations in said professional, technical and lay subjects, matters and fields*, said relational professional and technical terminologies-lay terminologies analogies specifying said initiating, receiving and requesting networked repositories what to and how to synchronously and spontaneously constituting, getting, pushing, receiving, rendering and reverse compose and updating same, equivalent and similar real-time useful, meaningful and comprehensible copies of events- and time-specific associations comprising updated engineered phenotypes data and relating innate data, expressions and manifestations in said professional, technical and lay subjects, matters and fields* associating with specific individuals and specific groups of individuals based on said amassed and bundled relational professional and technical terminologies and lay terminologies in said engineered phenotypes data, innate data and relational expressions and manifestations in said storage means in and among said networked repositories. Said operating system instructing said networked repositories amass and bundle said associations based on said networked repositories storing and compiling said rendered associations rendered by and among said networked repositories which are said ad libitum initiating, ad libitum receiving and/or ad libitum requesting networked repositories are associated with said individuals and groups of people. In other words, any of said networked repositories are the initiating, receiving and/or requesting networked repositories. And, enable by attached said very large analogies, any of said networked repositories can and do synchronously and spontaneously get, push, receive, render and reverse compose same, equivalent and similar useful, meaningful and comprehensible copies of said associations among said initiating, receiving and/or requesting networked repositories. For example, first, initiating networked repositories associating with professional and/or technical people use said analogies to render said copies of engineered professional and/or technical data and associations and push, sent and/or enable said engineered professional and/or technical data and associations as same, equivalent and similar useful, meaningful and comprehensible lay versions of copies of said engineered professional and/or technical data and associations to receiving and/or requesting networked repositories associating with lay people. Second, initiating networked repositories associating with lay people use said analogies to render said copies of engineered lay data and associations and push, sent and/or enable said engineered lay data and associations as same, equivalent and similar useful, meaningful and comprehensible professional and/or technical versions of said copies of engineered lay data and associations to receiving and/or requesting networked repositories associating with professional and/or technical people, and vice versa. Further to supra, said processes are applicable to specific professional and technical sets of associations having professional and technical terminologies and corresponding same, equivalent and similar lay sets of said associations having lay terminologies associating with said stored analogies based on specific engineered phenotypes data generated in associations with plurality of specific first platforms by and among said networked repositories to render, express and manifest specifically useful and comprehensible sets in and among initiating and requesting networked repositories having same, equivalent and similar engineered phenotypes data, innate data and related associations associating with stored demographics data of professional and technical and lay individuals and groups of people.

Further to supra, said processes are applicable to specific professional and technical sets of associations having professional and technical terminologies and corresponding same, equivalent and similar lay sets of said associations having lay terminologies associating with said stored analogies based on specific engineered phenotypes data generated in associations with plurality of specific first platforms by and among said networked repositories to push said specifically useful and comprehensible sets in and among initiating and receiving networked repositories having same, equivalent and similar engineered phenotypes data, innate data and related associations associating with stored demographics data of professional and technical and lay individuals and groups of people. Said get, sent, pushed and received data and associations are in said plurality of interactive adaptable and editable scrollable platforms having associated pop-ups and drop-downs of relevant interactive associations of professional, technical and lay subjects, matters and fields*. In said plurality of interactive adaptable and editable scrollable platforms, said real-time associations can and are synchronously and repeatedly viewed, used, managed, edited and expanded in real-time by and among said networked repositories. Said associations are stored in and among said networked repositories wherein said processes are repeated.

The present invention provides said operating system to instructing said networked repositories hoar to create a system for inherently and constantly protecting and preventing said systems from intrusions and harms. The present invention, first security, provides said operating system instructing said networked repositories how to reciprocally rendering connectivities among accredited and recognized networked repositories and disconnectivities among discredited and rejected networked repositories. Second security rendered by said networked repositories, said operating system instructing said networked repositories to spontaneously and constantly render and apply the rendered networked repositories-specific, real-time accountings of the number of usages of specific combinations of characters and specific types of said analogies between and among networked repositories consequent to said processes. Said accredited and connected repositories to automatically metamorphosizing said compilations and/or accountings relating networked repositories-specific same, equivalent and similar useful, meaningful and comprehensible subjects-, categories- and subcategories-specific copies of associations effected by said analogies. Said images and videos—described herein and displayed in said viewing screens—having interactive markings and labels some of which associating with said real-time accountings. Third security rendered by said networked repositories, said operating system instructing said networked repositories to spontaneously and constantly render and apply the rendered networked repositories-specific real-time accountings of individual repositories metamorphosizing compilations and accountings of usages of said subjects, categories and subcategories in said relational professional, technical and lay subjects, matters and fields*. Fourth security rendered by said networked repositories, adaptable sequences of interactive images and videos—described herein and displayed in said viewing screens—peculiar and/or idiosyncratic to individual networked repositories. A plurality of encryption software of said data and email addresses, passwords and electronic identities of said networked repositories and commercial security software and hardware will also be used to protect said systems.

1. A system for inferring extrapolating and foretelling needs, necessities and utilizations of tangible and intangible resources and assets by network, said system having an operating system for instructing and specifying networked repositories what to and how to express and manifest innate implicit and explicit data embodied in engineered phenotypes data, said innate data representing the biological and phenotypic expressions of genomes and associating occurrences and sequelae which are biological and functional constitutions and activities of individuals and groups of people associating with said networked repositories, said operating system for instructing said networked repositories what to and how to constitute, engineer and render said engineered phenotypes data whenever said networked repositories associating elements of said phenotypes data with a means for engineering said innate data and expressing and manifesting said associations and a means for effecting, said networked repositories to synchronously and spontaneously get, push and render, receive and reverse compose same, equivalent and similar amassed and bundled useful, meaningful and comprehensible said associations based on engineered phenotypes data and innate data by and among initiating, requesting and receiving networked repositories and said operating system for instructing said networked repositories to utilize rendered networked repositories-specific associations to render a constant self-protection of said systems, said system comprising: the Internet, commercial networking means and firewalls, a plurality of cloud software and web browsers, cloud servers networking with desktops and mobile communication devices including smartphones henceforth, collectively, devices said devices having said operating system for managing said devices, said devices having said networked repositories which are cloud, initiating, receiving and requesting networked repositories comprising processing means, storage means for storing means and data, identities and display screens including touch-sensitive screens;
a plurality of first interactive electronic platforms for constituting and engineering said innate data intrinsic in engineered phenotypes data whenever said networked repositories associating elements of said phenotypes data with a means for engineering said phenotypes data and expressing and manifesting said innate data in said engineered phenotypes data being expressed and manifested by said first interactive electronic platforms by and among said networked repositories;
said plurality of first interactive electronic platforms for expressing and manifesting adaptable and editable hierarchy data embodying said means for engineering said phenotypes data and means for engineering and manifesting said innate data, expressions and manifestations and related by and among said networked repositories;
a plurality of second interactive electronic platforms for constituting and rendering said means for engineering said phenotypes data and expressing and manifesting said innate data endowed in said engineered phenotypes data and related expressions and manifestations and related endowed and expressed and manifested by said first interactive electronic platforms by and among said networked repositories;
a plurality of third interactive electronic platforms for constituting and rendering said phenotypes data by and among said networked repositories, said phenotypes data having data components of said hierarchy data and said means;
said phenotypes data for initiating and effecting said expressions, manifestations and associations and for specifying said networked repositories to express and manifest said innate data and said associations whenever said networked repositories associating sequences of elements of said phenotypes data with said means for engineering said phenotypes data and expressing and manifesting said innate data endowed in said engineered phenotypes data and said associations;
said engineered phenotypes data for specifying specific initiating, receiving and requesting networked repositories to to get, push, receive and render repositories-specific innate data and said associations whenever said networked repositories associated sequences of elements of said engineered phenotypes data with said means for engineering said phenotypes data and expressing and manifesting said associations in and among said networked repositories;
said operating system for instructing said networked repositories what to and how to constitute, render and manifest said plurality of first and second interactive platforms having said hierarchy data endowed with said means for engineering said phenotypes data and expressing and manifesting said associations in said storage means by and among said networked repositories;
said operating system for instructing said networked repositories how to match said engineered phenotypes data endowed with innate data with same, similar or equivalent stored phenotypes data associating with expressions and manifestations and related in and among said storage means whenever said networked repositories engineering sequences of elements of said phenotypes data in associations with said means for engineering said phenotypes data and expressing and manifesting said expressions and manifestations by said first interactive electronic platforms by and among said networked repositories;
a means for effecting said networked repositories to synchronously and spontaneously render, get and receive same, equivalent and similar amassed and bundled useful, meaningful and comprehensible expressed and manifested phenotypes data, innate data, expressions, manifestations and related trends and patterns by and among networked repositories;
said operating system for rendering a plurality of software, said software and products for instructing said networked repositories what to and how to constitute and render said plurality of interactive platforms endowed with said means, said data, associations, products and outcomes in and among said networked repositories;
said associations comprising stored and compiled engineered phenotypes data endowed with innate data, patterns and trends associating with said hierarchy data and means for engineering, expressing and manifesting said data and associations in and among said networked repositories;
said operating system for instructing said networked repositories to store and compile said data and associations in said storage means; and
said storage means for storing said software, data and associations, products and outcomes in and among said networked repositories.

2. The system according to claim 1 wherein said data include said biological data, elements, copies, expressions and manifestations and related comprise terminologies and analogues, subjects-, categories- and subcategories-specific relational professional and technical, technical terminologies and lay terminologies comprise professional and technical, technical and lay words, terms, phrases, sentences, images, videos having time, temporal, characters, features, demographics, 2-D and 3-D spatial indicators, specificities, locations, places and events specificities and any combination thereof.

3. The system according to claim 1 wherein said engineered phenotypes data comprise hierarchies of professional and technical terminologies and lay terminologies in said hierarchy data and hierarchies of data in said means for engineering said phenotypes data and said means for engineering and manifesting said innate data, expressions and manifestations and related in said storage means.

4. The system according to claim 1 where said means said plurality of software in and among said networked repositories are:
the abiotics biotics data-abiotics biotics specificities software for instructing said networked repositories what to constitute and render relational abiotics biotics data-abiotics biotics specificities data;
the goods-services category-subcategory-abiotics biotics specificities software for instructing said networked repositories what to constitute and render relational goods-services category-subcategory-abiotics biotics specificities data;
the differential diagnostics software for instructing said networked repositories what to constitute and render categories of diagnostics data for defining and identifying individual said associations;
the professional and technical Terminologies-Lay Terminologies Thesaurus software for instructing said networked repositories what to and how to constitute and render relational professional and technical terminologies-lay terminologies analogies.

5. The system according to claim 1 where said means for engineering said phenotypes data and expressing and manifesting said innate data endowed in said engineered phenotypes data and related expressions and manifestations and related comprise:
said relational goods-services category-subcategory-abiotics biotics specificities data are said means for said networked repositories to engineer said innate data endowed in said engineer phenotypes data;
said relational goods-services category-subcategory-abiotics biotics specificities data are said said networked repositories to engineer said innate data endowed in said engineer phenotypes data;
said categories of diagnostics data are means for said networked repositories to pattern, trend and align said innate data with patterns, trends and alignments of said expressions and manifestations stored in said storage means;
said networked repositories-rendered plurality of first interactive electronic platforms for constituting and engineering said innate data intrinsic in engineered phenotypes data, said first interactive electronic platforms having adaptable and editable hierarchy data embodied with said means;
said networked repositories for expressing and manifesting said innate data in said engineered sequences of elements of phenotypes data in associations with said networked repositories-rendered adaptable and editable hierarchy data and expressing and manifesting said innate data endowed in said engineered phenotypes data;
said relational abiotics biotics data-abiotics biotics specificities data for specifying said networked repositories how to engineer sequences of elements in said phenotypes data so that said engineered phenotypes data are endowed with correct and accurate data patterns and trends which are same as, equivalent and similar to or align with data patterns and trends of said expressions and manifestations associating with said related stored in said storage means;
said relational goods-services category-subcategory-abiotics biotics specificities data for specifying said networked repositories how to engineer sequences of elements in said phenotypes data so that said engineered phenotypes data are endowed with correct and accurate data patterns and trends which are same as, equivalent and similar to or align with data patterns and trends of said expressions and manifestations associating with said related stored in said storage means; and categories of diagnostics data embodied in said plurality of first interactive electronic platforms for engineering and managing said patterns, trends and alignments of said innate data and of patterns and trends of said expressions and manifestations associating with said related stored in said storage means.

6. The system according to claim 1 wherein said means for effecting said networked repositories to synchronously and spontaneously get, push and render, receive and reverse compose same, equivalent and similar amassed and bundled useful, meaningful and comprehensible said associations based on engineered phenotypes data and innate data by and among initiating, requesting and receiving networked repositories comprises:
said networked repositories for engineering and rendering engineered sequences of elements of phenotypes data in associations with said networked repositories-rendered adaptable and editable hierarchy data endowed with said means for engineering said engineered phenotypes data;
said means for engineering said phenotypes data and expressing and manifesting said innate data endowed in said engineered phenotypes data and related;
said networked repositories for amassing and bundling said innate data, expressions and manifestation and related based on relations of engineered sequences of elements of phenotypes data, sequences of elements of said means for said networked repositories to engineer said innate data endowed in said engineer phenotypes data and sequences of elements of said means for said networked repositories to pattern, trend and align said innate data in said storage means;
said relational professional and technical terminologies-lay terminologies analogies for specifying said initiating, receiving and requesting networked repositories what to and how to synchronously and spontaneously constituting and getting same, equivalent and similar real-time useful, meaningful and comprehensible copies of said innate data, expressions and manifestations and related associating with individuals and groups of individuals based on amassed and bundled relational professional and technical terminologies and lay terminologies in said engineered phenotypes data, innate data, expressions and manifestations in said storage means;
said relational professional and technical terminologies-lay terminologies analogies for specifying said initiating, receiving and requesting networked repositories that to and how to synchronously and spontaneously constituting and getting same, equivalent and similar real-time useful, meaningful and comprehensible specific copies of sets of events and time-specific innate data, expressions and manifestations and related associating with specific individuals and specific groups of individuals based on amassed and bundled relational professional and technical terminologies and lay terminologies in said engineered phenotypes data, innate data, expressions and manifestations in said storage means; and
said initiating, requesting and receiving networked repositories having accredited and recognized network connectivities.

7. The system according to claim 1 where said means for specifying said networked repositories what to and how to pattern, trend and align said innate data comprise:
said engineered phenotypes data in associations with said networked repositories-rendered adaptable and editable hierarchy data and expressing and manifesting said innate data endowed in said engineered phenotypes data;
said plurality of first interactive electronic platforms endowed with said means for engineering said phenotypes data and expressing and manifesting said innate data endowed in said engineered phenotypes data and related;
said plurality of first interactive electronic platforms endowed with said means for engineering said phenotypes data and expressing and manifesting said innate data endowed in said engineered phenotypes data and related to express and manifest said said innate data in said engineered phenotypes data and related; and
said means for effecting said networked repositories to synchronously and spontaneously render, get and receive same, equivalent and similar amassed and bundled useful, meaningful and comprehensible expressed and manifested innate data and related by and among said initiating, receiving and requesting networked repositories; and
said storage means for storing said associations in and among said networked repositories.

8. The system according to claim 1 wherein said engineered phenotypes data for specifying specific initiating, receiving and requesting, networked repositories to render, get and receive specific innate data, expressions and manifestations and related whenever said networked repositories associated sequences of elements of said engineered phenotypes data with said means for engineering, said phenotypes data and expressing and manifesting said specific innate data, expressions and manifestations and related comprises:
said relations of specific engineered sequences of elements of engineered phenotypes data in associations with specific sequences of elements of said means for said networked repositories to engineer said innate data endowed in said engineered phenotypes data and specific sequences of elements of said means for said networked repositories to pattern, trend and align said innate data in and among said networked repositories; and
said relational professional and technical terminologies-lay terminologies analogies for specifying said initiating, receiving and requesting specific networked repositories what to and how to synchronously and spontaneously constituting and getting same, equivalent and similar real-time useful meaningful and comprehensible repositories-specific copies of sets of said innate data, expressions and manifestations and related associating with specific individuals and specific groups of individuals based on amassed and bundled relational professional and technical terminologies and lay terminologies in said engineered phenotypes data, innate data, expressions and manifestations in and among said networked repositories.

9. The system according to claim 1 wherein said operating system for instructing said networked repositories to utilize rendered networked repositories-specific associations to render a constant self-protection of said systems, said associations comprise:
said networked repositories for reciprocally rendering connectivities among accredited and recognized networked repositories and for rendering disconnectivities among discredited and rejected networked repositories;
said networked repositories for spontaneously and constantly rendering and applying rendered networked repositories-specific real-time accountings of said usages of specific combinations of characters and specific types of said analogies between and among networked repositories;
said accredited and connected repositories for automatically metamorphosizing said compilations and/or accountings relating networked repositories-specific same, equivalent and similar useful, meaningful and comprehensible copies of associations effected by said analogies;
metamorphosizing compilations and/or accountings of relating networked repositories-specific same, equivalent and similar useful, meaningful and comprehensible subjects-, categories- and subcategories-specific associations rendered by said means for effecting said networked repositories to synchronously and spontaneously get and receive same, equivalent and similar useful, meaningful and comprehensible said associations;
metamorphosizing compilations and/or accountings of usages of said subjects, categories and subcategories by said networked repositories;
said images and videos having interactive markings and labels some of which associating with said real-time accountings in said display screens;
adaptable sequences of interactive images and videos peculiar and/or idiosyncratic to individual networked repositories;
a plurality of encryption software of said data and email addresses, passwords and electronic identities of said networked repositories and commercial security software and hardware will also be used to protect said systems.

10. In a system for inferring, extrapolating and foretelling needs, necessities and utilizations of tangible and intangible resources and assets by network, a method of an operating system instructing and specifying networked repositories to engineer phenotypes data to express and manifest innate implicit and explicit inherent data embodied in engineered phenotypes data, said innate data representing biological and phenotypic expressions and manifestations of genomes and related occurrences and sequelae which are biological and functional constitutions and activities of individuals and groups of people associating with said networked repositories, operating system instructing said networked repositories to constitute, engineer and render said engineered phenotypes data whenever said networked repositories associating elements of phenotypes data, with a means for engineering said phenotypes data and expressing and manifesting said engineered phenotypes data and related expressions and manifestations and related occurrences and sequelae, and by associating with said means, said engineered phenotypes data initiating networked repositories to amass and bundle said associations, said operating system instructing said networked repositories to synchronously and spontaneously get, push, receive, render and reverse compose same, equivalent and similar amassed and bundled useful, meaningful and comprehensible copies of said associations based on engineered phenotypes data and innate data by and among initiating, requesting and receiving networked repositories and said operating system instructing said networked repositories how to utilize said rendered networked repositories-specific associations to constantly protecting said systems, said method comprises processes for:
said cloud servers to create said operating system and attaching said operating system to said networked repositories;
utilizing the Internet, commercial networking means and firewalls, a plurality of cloud software and web browsers, cloud servers networking with desktops and mobile communication devices including smartphones henceforth, collectively, devices, said devices having said operating system for managing said devices, said devices having said networked repositories which are cloud, initiating, receiving and requesting networked repositories comprising processing means, storage means for storing means and data, identities and display screens;
said networked repositories constituting and rendering a plurality of adaptable and editable first interactive electronic platforms to engineer, express and manifest said hierarchy data embodied with said means for engineering, expressing and manifesting;
said networked repositories rendering said plurality to constitute and engineer said innate data intrinsic in phenotypes data being engineered whenever initiating, receiving and requesting networked repositories associating sequences of elements of said phenotypes data with said hierarchy data embodied with said means expressed and manifested in said plurality to express and manifest innate data by engineering said phenotypes data based on said stored and compiled associations by and in said networked repositories;
said networked repositories using said plurality of first interactive electronic platforms to express and manifest said innate data in said engineered phenotypes data and to constitute and render adaptable and editable hierarchy data embodying said means for engineering and expressing and manifesting by and among said networked repositories;
said operating system instructing said networked repositories how to render a plurality of second interactive electronic platforms to constitute and render said means for engineering said phenotypes data and expressing and manifesting said innate data in said engineered phenotypes data to express and manifest said innate data in said engineered phenotypes data and related expressions and manifestations and related based on stored phenotypes data associating with patterns and trends of expressions and manifestations and related in and among said storage means;
said plurality of second interactive electronic platforms constituting and rendering said means for engineering said phenotypes data and expressing and manifesting said innate data endowed in said engineered phenotypes data and related expressions and manifestations and related by said first interactive electronic platforms in and among said networked repositories;
said networked repositories to render a plurality of third interactive electronic platforms to constitute and render said phenotypes data having data components of said hierarchy data and said means;
said networked repositories to to match said engineered phenotypes data endowed with innate data with same, similar or equivalent stored phenotypes data endowed with innate data associating with compiled and stored associations in and among said storage means whenever said networked repositories engineering sequences of elements of said phenotypes data by associating said elements with expressed and manifested associations in said plurality of first interactive platforms;
said operating system rendering a plurality of software to instruct said networked repositories what to and how to constitute, render and engineer said engineered phenotypes data and associating associations and endowed innate data and what to and how to get, push, receive and render compiled and stored associations in and among said networked repositories;
said operating system instructing said networked repositories what to and how to constitute, render and manifest said plurality of first and second interactive platforms having said means for engineering, expressing and manifesting said innate data, expressions and manifestations and related by and among said networked repositories;
said engineered phenotypes data specifying said networked repositories to express and manifest innate data, expressions and manifestations and related whenever said networked repositories associated sequences of elements of said engineered phenotypes data with said means for engineering, expressing and manifesting said engineered phenotypes data and innate data and associating expressions and manifestations and related among said networked repositories;
said engineered phenotypes data specifying specific initiating, receiving and requesting networked repositories to get, push, receive and render repositories-specific innate data, expressions and manifestations and related whenever said networked repositories associated sequences of elements of said engineered phenotypes data with said means for engineering said phenotypes data and to express and manifest said specific innate data, expressions and manifestations and related by and among said initiating, receiving and requesting networked repositories;
said operating system instructing said networked repositories to synchronously and spontaneously get, push, receive, render and reverse compose same, equivalent and similar amassed and bundled useful, meaningful and comprehensible real-time copies of said associations by and among initiating, requesting and receiving associating with individuals and groups of people;
said operating system instructing said networked repositories to store said relational data and means in said storage means; and
said storage means storing said software and data and said products of associations of said data and products.

11. The process of said operating system rendering a plurality of software to instruct said networked repositories what to and how to constitute, render and engineer said engineered phenotypes data and associating associations and endowed innate data and what to and how to get, push, receive and render compiled and stored associations according to claim 10 comprises processes for operating system to instruct said networked repositories to render;
said abiotics biotics data-abiotics biotics specificities software to instruct said networked repositories what relational abiotics biotics data-abiotics biotics specificities data to constitute and render;
said goods-services category-subcategory-abiotics biotics specificities software to instruct said networked repositories what relational goods-services category-subcategory-abiotics biotics specificities data to constitute and render;
said differential diagnostics software to instruct said networked repositories what categories of diagnostics data to constitute and render;
said professional and technical terminologies-lay terminologies thesaurus software to instruct said networked repositories what relational professional and technical terminologies-lay terminologies analogies to constitute and render; and
said data and analogies to specify said networked repositories what to and how to define, render and identify individual components of associations and individual said associations in and among said networked repositories.

12. The process for said networked repositories to match said engineered phenotypes data endowed with innate data with same, similar or equivalent stored phenotypes data endowed with innate data associating with compiled and stored associations in and among said storage means according to claim 10 comprises processes for said operating system to instruct said networked repositories to:
associate individual sequences of elements in phenotypes data to be endowed with innate data with said plurality of adaptable and editable first interactive electronic platforms endowed with said means;
use said associations to render correct or accurate engineered phenotypes data and innate data having trends or patterns to be same as, equivalent or similar to compiled and stored phenotypes data endowed with innate data having trends or patterns associating with expressions and manifestations and related events, consequences and sequelae by and among said storage means by using individual networked repositories-rendered adaptable and editable hierarchy data endowed with said means wherein said networked repositories expressing and manifesting said means as adaptable and editable relational abiotics biotics data-abiotics biotics specificities data, goods-services category-subcategory-abiotics biotics specificities data and diagnostics data to specify and guide said networked repositories what to and how to engineered said sequences of elements in said phenotypes data and expressing and manifesting said expressions and manifestations and related, said networked repositories expressing and manifesting said means as adaptable, editable and manageable relational data in and among said viewing screens;
compile and store said associations of said data and associating patterns and trends in and among said networked repositories;
amass and bundle said associations based on engineered sequences of elements in phenotypes data and associating innate data and said expressions and manifestations and related;
synchronously and spontaneously render, push and get same, equivalent and similar real-time useful, meaningful and comprehensible copies of engineered phenotypes data and innate data and related expressions, manifestations and related extrapolations, inferences and foretells based on said networked repositories using individual networked repositories-rendered adaptable and editable hierarchy data wherein said networked repositories expressing and manifesting said means as adaptable and editable relational data and diagnostics data to specify and guide said networked repositories what to and how to engineered said sequences of elements in said phenotypes data and express and manifest expressions and manifestations and related;
synchronously and spontaneously render, push and get same, equivalent or similar real-time useful, meaningful and comprehensible copies of specific networked repositories-specific sets of engineered phenotypes data and innate data, expressions and manifestation and related based on said networked repositories using individual networked repositories-rendered adaptable and editable hierarchy data wherein said networked repositories expressing and manifesting said means as adaptable and editable relational data and diagnostics data to specify and guide said networked repositories what to and how to engineered said specific sequences of elements in said phenotypes data to express and manifest specific sequences of elements in said means endowing said plurality to express and manifest said real-time useful, meaningful and comprehensible copies by and among initiating, receiving and requesting networked repositories associating with individuals and groups of people;
express and manifest said associations and associating patterns and trends in said plurality of adaptable and editable first interactive electronic interactive platforms associating with relevant means along said networked repositories and in scrollable adaptable and editable displays of said associations in said viewing screens;
compile and store said associations and relational outcomes and products in said storage means and expressing and manifesting said associations and relational outcomes and products in said viewing screens by and among initiating, requesting and receiving networked repositories; and
express and manifest said stored associations and relational outcomes and products in said scrollable adaptable and editable displays whenever said networked repositories engineering individual sequences of elements of phenotypes data in associations with said plurality of first interactive platforms with endowed means expressing and manifesting stored associations and relational outcomes and products in conjunctions with said endowed means relating to said individual sequences being engineered by and among networked repositories.

13. The process for said networked repositories using individual networked repositories-rendered adaptable and editable hierarchy data wherein said networked repositories expressing and manifesting said means as adaptable and editable relational data and diagnostics data to specify and guide said networked repositories what to and how to engineered said sequences of elements in said phenotypes data and express and manifest expressions and manifestations and related according to claim 10 comprises processes of said networked repositories;
getting said stored relational data comprising said relational associations and outcomes and products relating to said individual sequences of elements in said phenotypes data from said storage means whenever said networked repositories associating said individual sequences of elements with said adaptable and editable hierarchy data and associating means in said first interactive platforms by said networked repositories scanning and matching said elements in individual sequences with same, similar and equivalent elements in said relational data and related associations and related products and outcomes having patterns and trends stored in said storage means;
expressing and manifesting said retrieved relational data as adaptable and editable real-time expressions and manifestations of said hierarchy data and endowed means referencing to real-time sequences of elements of said phenotypes data being engineered in a plurality of first temples, and a plurality of interactive adaptable and editable scrollable data and pop-ups and drop-downs of real-time data possessing subjects-, categories- and subcategories-specific relational professional and technical, technical terminologies and lay terminologies and analogues comprise professional and technical, technical and lay words, terms, phrases, sentences, images, videos associating with time, temporal, characters, features, demographics, 2-D and 3-D features and specificities, locations, places and events and any combination thereof;
using said professional and technical terminologies-lay terminologies analogies in said storage means to synchronously and spontaneously render, push and get same, equivalent and similar real-time useful, meaningful and comprehensible copies of said associations by and among initiating, receiving and requesting networked repositories associating with individuals and groups of people based on said sequences of elements in and among initiating, receiving and requesting networked repositories; and
using said professional and technical terminologies-lay terminologies analogies in said storage means to synchronously and spontaneously render, push and get same, equivalent or similar real-time useful, meaningful and comprehensible copies of specific networked repositories-specific sets of said associations by and among specific initiating, receiving and requesting networked repositories associating with individuals and groups of people based on specific sets of sequences of elements in specific initiating, receiving and requesting networked repositories.

14. The process for said operating system instructing said networked repositories to synchronously and spontaneously get, push, receive, render and reverse compose same, equivalent and similar amassed and bundled useful, meaningful and comprehensible copies of said associations based on engineered phenotypes data and innate data by and among initiating, requesting and receiving networked repositories according to claim 10 comprises processes for said operating system instructing said networked repositories how to use said stored professional and technical terminologies-lay terminologies analogies in and among said networked repositories to:
amass and bundle said associations based on said networked repositories storing and compiling said rendered associations rendered by and among said networked repositories;
get stored professional and technical copies of associations having professional and technical terminologies and corresponding same, equivalent and similar lay copies of said associations having lay terminologies associating with said stored analogies in said storage means and to render, express and manifest said useful, meaningful and comprehensible copies in and among initiating and requesting networked repositories having same, equivalent and similar engineered phenotypes data, innate data and related associations associating with stored demographics data of professional and technical and lay individuals and groups of people; and
get stored professional and technical copies of associations having with professional and technical terminologies and corresponding same, equivalent and similar lay copies of said associations having lay terminologies associating with said stored analogies in said storage means and to push said useful, meaningful and comprehensible copies to and among initiating and receiving networked repositories having same, equivalent and similar engineered phenotypes data, innate data and related associations associating with stored demographics data of professional and technical and lay individuals and groups of people; and
said initiating, requesting and receiving networked repositories having accredited and recognized network connectivities to synchronously and spontaneously get, push, receive and render same, equivalent and similar copies of real-time associations.

15. The process for said operating system instructing said networked repositories to synchronously and spontaneously get, push, receive, render and reverse compose same, equivalent and similar amassed and bundled useful, meaningful and comprehensible copies of said associations based on engineered phenotypes data and innate data by and among initiating, requesting and receiving networked repositories according to claim 10 comprises processes for said operating system instructing said networked repositories how to use said stored professional and technical terminologies-lay terminologies analogies in and among said networked repositories to:
amass and bundle said associations based on said networked repositories storing and compiling said rendered associations rendered by and among said networked repositories;
get specific professional and technical sets of associations having professional and technical terminologies and corresponding same, equivalent and similar lay sets of said associations having lay terminologies associating with said stored analogies based on specific engineered phenotypes data generated in associations with plurality of specific first platforms by and among said networked repositories to render, express and manifest specifically useful and comprehensible sets in and among initiating and requesting networked repositories having same, equivalent and similar engineered phenotypes data, innate data and related associations associating with stored demographics data of professional and technical and lay individuals and groups of people; and
get specific professional and technical sets of associations having professional and technical terminologies and corresponding same, equivalent and similar lay sets of said associations having lay terminologies associating with said stored analogies based on specific engineered phenotypes data generated in associations with plurality of specific first platforms by and among said networked repositories to push said specifically useful and comprehensible sets in and among initiating and receiving networked repositories having same, equivalent and similar engineered phenotypes data, innate data and related associations associating with stored demographics data of professional and technical and lay individuals and groups of people; and
said initiating, requesting and receiving networked repositories having accredited and recognized network connectivities to synchronously and spontaneously get, push, receive and render same, equivalent and similar copies of real-time associations.

16. The process for said operating system instructing said networked repositories how to utilize said rendered networked repositories-specific associations to constantly protecting said systems according to claim 10 comprises processes for said operating system instructing said networked repositories including said accredited and connected repositories:
how to reciprocally rendering connectivities among accredited and recognized networked repositories and disconnectivities among discredited and rejected networked repositories;
to spontaneously and constantly render and apply networked repositories-specific real-time accountings of the number of usages of specific combinations of characters and specific types of said analogies between and among networked repositories consequent to said processes;
to automatically metamorphosizing said networked repositories-specific real-time accountings of said usages of specific combinations of characters and specific types of said analogies between and among networked repositories consequent to said processes;
to render and display images and videos hating interactive markings and labels some of which associating with said real-time accountings;
to spontaneously and constantly render and apply the rendered networked repositories-specific real-time accountings of individual repositories metamorphosizing compilations and accountings of usages of said subjects, categories and subcategories in said relational professional, technical and lay subjects, matters and fields*; and
to render and display images and videos adaptable sequences of interactive images and videos peculiar and idiosyncratic to individual networked repositories.

17. In a system for expressing and manifesting phenotypes expressions of genomes and related events and consequences representing arrays of biological and functional occurrences and constitutions of individuals and groups of people by network, a method for an operating system to instruct networked repositories to render, modify and compile said expressions and manifestations based on said operating system instructing said networked repositories how to constitute and engineer phenotypes data to be endowed with innate implicit and explicit data associating with compiled and stored expressions and manifestations whenever said networked repositories associating individual sequences of elements in said phenotypes data with a plurality of adaptable and editable hierarchy data endowed with said means for engineering said phenotypes data and expressing and manifesting said innate data endowed in said engineered phenotypes data to associate with said expressions and manifestations and said operating system instructing said networked repositories how to amass and bundle said associations, to synchronously and spontaneously get, push, receive, render and reverse compose same, equivalent and similar real-time copies of said associations to be expressed and manifested in plurality of said adaptable and editable interactive platforms based on said engineered phenotypes data and innate data by and among initiating, requesting and receiving networked repositories and to utilize said rendered networked repositories-specific associations to constantly protecting said systems, said method comprising processes of:
said cloud servers to create said operating system and attaching said operating system to said networked repositories;
utilizing the Internet, commercial networking means and firewalls, a plurality of cloud software and web browsers, cloud servers networking with desktops and mobile communication devices including smartphones henceforth, collectively, devices, said devices having said operating system for managing said devices, said devices having said networked repositories which are cloud, initiating, receiving and requesting networked repositories comprising processing means, storage means for storing means and data, identities and display screens;
said networked repositories constituting and rendering a plurality of adaptable and editable first interactive electronic platforms to engineer, express and manifest said hierarchy data embodied with said means for engineering, expressing and manifesting;
said networked repositories rendering said plurality to constitute and engineer said innate data intrinsic in phenotypes data being engineered whenever initiating, receiving and requesting networked repositories associating sequences of elements of said phenotypes data with said hierarchy data embodied with said means expressed and manifested in said plurality to express and manifest innate data by engineering said phenotypes data based on said stored and compiled associations by and in said networked repositories;
said networked repositories using said plurality of first interactive electronic platforms to express and manifest said innate data in said engineered phenotypes data and to constitute and render adaptable and editable hierarchy data embodying said means for engineering and expressing and manifesting by and among said networked repositories;
said operating system instructing said networked repositories how to render a plurality of second interactive electronic platforms to constitute and render said means for engineering said phenotypes data and expressing and manifesting said innate data in said engineered phenotypes data to express and manifest said innate data in said engineered phenotypes data and related expressions and manifestations and related based on stored phenotypes data associating with patterns and trends of expressions and manifestations and related in and among said storage means;
said plurality of second interactive electronic platforms constituting and rendering said means for engineering said phenotypes data and expressing and manifesting said innate data endowed in said engineered phenotypes data and related expressions and manifestations and related by said first interactive electronic platforms in and among said networked repositories;
said networked repositories to render a plurality of third interactive electronic platforms to constitute and render said phenotypes data having data components of said hierarchy data and said means;
said networked repositories to to match said engineered phenotypes data endowed with inmate data with same, similar or equivalent stored phenotypes data endowed with innate data associating with compiled and stored associations in and among said storage means whenever said networked repositories engineering sequences of elements of said phenotypes data by associating said elements with expressed and manifested associations in said plurality of first interactive platforms;
said operating system rendering a plurality of software to instruct said networked repositories what to and how to constitute, render and engineer said, engineered phenotypes data and associating associations and endowed innate data and what to and how to get, push, receive and render compiled and stored associations in and among said networked repositories;
said operating system instructing said networked repositories what to and how to constitute, render and manifest said plurality of first and second interactive platforms having said means for engineering, expressing and manifesting said innate data, expressions and manifestations and related by and among said networked repositories;
said engineered phenotypes data specifying said networked repositories to express and manifest innate data, expressions and manifestations and related whenever said networked repositories associated sequences of elements of said engineered phenotypes data with said means for engineering, expressing and manifesting said engineered phenotypes data and innate data and associating expressions and manifestations and related among said networked repositories;
said engineered phenotypes data specifying specific initiating, receiving and requesting networked repositories to get, push, receive and render repositories-specific innate data, expressions and manifestations and related whenever said networked repositories associated sequences of elements of said engineered phenotypes data with said means for engineering said phenotypes data and to express and manifest said specific innate data, expressions and manifestations and related by and among said initiating, receiving and requesting networked repositories;
said operating system instructing said networked repositories to synchronously and spontaneously get, push, receive and render same, equivalent and similar copies of real-time associations by and among said networked repositories associating with individuals and groups of people;
said operating system instructing said networked repositories to utilize rendered networked repositories-specific products by said means to render a constant self-protection of said systems;
said operating system instructing said networked repositories to store said relational data and means in said storage means; and
said storage means storing said software and data and said products of associations of said data and products.

18. The process for said operating system instructing said networked repositories to synchronously and spontaneously get, push, receive, render and reverse compose same, equivalent and similar real-time copies of said associations to be expressed and manifested in plurality of said adaptable and editable interactive platforms by and among initiating, requesting and receiving networked repositories according to claim 17 comprises a process for said operating system instructing said networked repositories how to use said stored professional and technical terminologies-lay terminologies analogies in and among said networked repositories to: amass and bundle said associations based on said networked repositories storing and compiling said rendered associations rendered by and among said networked repositories;
get stored professional and technical copies of associations having professional and technical terminologies and corresponding same, equivalent and similar lay copies of said associations having lay terminologies associating with said stored analogies in said storage means and to render, express and manifest said useful, meaningful and comprehensible copies in and among initiating and requesting, networked repositories having same, equivalent and similar engineered phenotypes data, innate data and related associations associating with stored demographics data of professional and technical and lay individuals and groups of people;
get stored professional and technical copies of associations having with professional and technical terminologies and corresponding same, equivalent, and similar lay copies of said associations having lay terminologies associating said stored analogies in said storage means and to push said useful, meaningful and comprehensible copies to and among initiating and receiving networked repositories having same, equivalent and similar engineered phenotypes data, innate data and related associations associating with stored demographics data of professional and technical and lay individuals and groups of people; and
said initiating, requesting and receiving networked repositories having accredited and recognized network connectivities to synchronously and spontaneously get, push, receive and render same, equivalent and similar copies of real-time associations.

19. The process for said operating system instructing said networked repositories to synchronously and spontaneously get, push, receive, render and reverse compose same, equivalent and similar real-time copies of said associations to be expressed and manifested in plurality of said adaptable and editable interactive platforms by and among initiating, requesting and receiving networked repositories according to claim 17 comprises a process for said operating system instructing said networked repositories how to use said stored professional and technical terminologies-lay terminologies analogies in and among said networked repositories to:
amass and bundle said associations based on said networked repositories storing and compiling said rendered associations rendered by and among said networked repositories;
get specific professional and technical sets of associations having professional and technical terminologies and corresponding same, equivalent and similar lay sets of said associations having lay terminologies associating with said stored analogies based on specific engineered phenotypes data generated in associations with plurality of specific first platforms by and among said networked repositories to render, express and manifest specifically useful and comprehensible sets in and among initiating and requesting networked repositories having same, equivalent and similar engineered phenotypes data, innate data and related associations associating with stored demographics data of professional and technical and lay individuals and groups of people;
get specific professional and technical sets of associations having professional and technical terminologies and corresponding same, equivalent and similar lay sets of said associations having lay terminologies associating with said stored analogies based on specific engineered phenotypes data generated in associations with plurality of specific first platforms by and among said networked repositories to push said specifically useful and comprehensible sets in and among initiating and receiving networked repositories having same, equivalent and similar engineered phenotypes data, innate data and related associations associating with stored demographics data of professional and technical and lay individuals and groups of people; and
said initiating, requesting and receiving networked repositories having accredited and recognized network connectivities to synchronously and spontaneously get, push, receive and render same, equivalent and similar copies of real-time associations.

20. The process for said operating system instructing said networked repositories how to utilize said rendered networked repositories-specific associations to constantly protecting said systems according to claim 17 comprises processes for said operating system instructing said networked repositories including said accredited and connected repositories:
how to reciprocally rendering, connectivities among accredited and recognized networked repositories and disconnectivities among discredited and rejected networked repositories;
to spontaneously and constantly render and apply networked repositories-specific real-time accountings of the number of usages of specific combinations of characters and specific types of said analogies between and among networked repositories consequent to said processes;
to automatically metamorphosizing said networked repositories-specific real-time accountings of said usages and types of said analogies between and among networked repositories consequent to said processes;
to render and display images and videos having interactive markings and labels some of which associating with said real-time accountings;
to spontaneously and constantly render and apply the rendered networked repositories-specific real-time accountings of individual repositories metamorphosizing compilations and accountings of usages of said subjects, categories and subcategories in said relational professional, technical and lay subjects, matters and fields*; and
to render and display images and videos adaptable sequences of interactive images and videos peculiar and idiosyncratic to individual networked repositories.
